(19) United States
(12) Patent Application Publication
(10) Pub. No.: US 2011/0288963 A1
(43) Pub. Date: Nov. 24, 2011

(54) Method of Giving, Receiving and Redeeming Virtual and Real Gifts

(76) Inventor: Steven N. Verona, Miami Beach, FL (US)

(21) Appl. No.: 13/111,510

(22) Filed: May 19, 2011

Related U.S. Application Data
(60) Provisional application No. 61/346,053, filed on May 19, 2010.

(51) Int. Cl. G06Q 30/00

(52) U.S. Cl. 705/27.1

(57) ABSTRACT

A method of conveying virtual and real gifts from one entity to another that includes unique benefits to the sender and the recipient. The sender purchases a virtual gift and real gift features, and the recipient receives both the real and the virtual gift if he or she accepts the virtual gift and complies with the requirements of acceptance. The real gift features motivate the recipient to accept the virtual gift.

### CROSS-REFERENCES TO RELATED APPLICATIONS

This application claims the benefit of U.S. Provisional Application No. 61/346,053 filed May 19, 2010. This prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

The invention is a method of conveying virtual and real gifts from one person to another.

Facebook, bebo, Hi5, MySpace, and other online and non-online businesses have offered a combination of virtual gifts and physical gifts that can be purchased with a virtual currency. Customers obtain the virtual currency via actions such as completing online offers or surveys and by purchasing with traditional currency. Existing virtual gifting has no intrinsic value, because the gifts exist only in the virtual world in electronic form with no way to convert the gifts to the real world. Virtual gifts are purchased with virtual currency and the image of the virtual gift is transmitted to a recipient. The recipient receives the image of the gift and the limited positive goodwill of knowing the sender thought of him or her in relation to the virtual gift. Traditional physical gifts have intrinsic value because they can be utilized, returned, sold for real currency or “re-gifted” (i.e., given to a third party).

In addition to virtual gifting, virtual worlds such as SecondLife have created entire economies around their offerings. The SecondLife virtual world interacts with the real world via the sale of services in the real world to provide something in the SecondLife world.

### BRIEF SUMMARY OF THE INVENTION

Semi-virtual products and services according to the invention bridge the gap between virtual gifts and physical (traditional or real-world) gifts by combining the benefits of both into a new offering. A semi-virtual gift is purchased and the virtual portion is delivered in the same manner as a virtual gift—a person uses a web site or other communication device (cell phone, text message, email, etc.) to transmit funds to a computer, which transmits back to the person or to a recipient an electronic file that contains information about the “gift”.

The recipient of a semi-virtual gift derives the same benefits as one derives from a virtual gift along with intrinsic, real-world value that one derives from a real-world gift. The intrinsic, real-world value of a semi-virtual gift can be realized in many ways. The semi-virtual gift can be returned to the store for real money (or other valuable consideration, such as credit and other products) or for virtual money that can be used to purchase virtual gifts. Alternatively, the semi-virtual gift can include a monetary value attached to it. This monetary value is realized by the recipient in a number of ways. One way is by “accepting” the gift, which can include the receipt by the recipient of real-world money, credit or products that are a portion of the amount spent on the virtual gift. Another is by “clicking” on (in a web or other computer-based environment) a “return” indicium to return the gift. The recipient can also “re-gift” the semi-virtual gift, such as by simply transmitting the gift's image and accompanying unique identifying data and value, to a third party.

Alternatively, the recipient can keep the gift and also keep the possible right to a transformation from the virtual item to a real item (herein, “virtual to real” is abbreviated “V2R”). The V2R transformation can be conducted using a conventional sweepstakes or other random drawing in which one or more entrants are selected as the winner(s). This results in the winning recipient and/or sender of the gift winning the real item that the virtual gift represents, or something of similar value, such as currency or equal credit at a particular store. Typically, such a selection will be accomplished by a random selection among all gifts that meet the eligibility requirements.

### BRIEF DESCRIPTION OF THE SEVERAL VIEWS OF THE DRAWINGS

FIG. 1 is a schematic view illustrating an embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Patent application Ser. No. 61/346,053 filed May 19, 2010, is incorporated in this application by reference.

The invention includes the purchase of a virtual gift that has some real-world connection. The real-world connection can be the entry of the virtual gift giver and/or recipient in a real-world contest, such as a sweepstakes or other random drawing contest. The real-world connection can alternatively or additionally be the recipient of the semi-virtual gift receiving, in addition to a virtual gift, some portion of value of the virtual gift if the virtual gift were real. For example, a giver of a virtual bottle of wine with a real-world value of twenty dollars who pays two real dollars to send to a recipient the virtual bottle of wine in the form of a photographic image viewable on any computer, transfers to the recipient of the gift one real dollar (half of the amount paid by the sender of the semi-virtual gift) in her account if she accepts the gift. The real dollar can be spent by the recipient as conventional currency. Alternatively or additionally, some portion of the real value of the gift can be accounted to the recipient in virtual money. For example, ten of the twenty dollars the real bottle of wine would cost can be accounted to the recipient in virtual dollars that can be spent by the recipient on semi-virtual gifts to the sender or to third parties. Alternatively, these semi-virtual dollars can be accumulated and spent on real items in a V2R transformation, similarly to how points on a credit card are accumulated due to purchases that can be spent by the credit card holder on real products.

The first recipient can accept the gift and then send it to a third party (re-gift), who receives the image of the gift along with half of the real money the recipient received. The recipient loses the right to use the other half of the money she received by re-gifting the gift. The third party can be given the same virtual ten dollars the recipient received, or some smaller amount to indicate the fact that it is a re-gift. The retention by the company that operates the web site for the semi-virtual gift of half of the money spent by senders assists the company in operating its web site. Of course, the amount retained can be more or less than one half.

Another transformation of the virtual gift to the real world is in the operation of a contest. In one example of the invention, the sender and recipient of each semi-virtual gift purchased during a predetermined time period are automatically entered into a pool of candidates. Alternatively, the entering can be manual, such as by allowing the sender and the recipient to “opt in”. At the end of the predetermined time period, one or more of the candidates are chosen to receive the real-world equivalent of their semi-virtual gift. For example, anyone sending and anyone receiving a semi-virtual TIMEX brand watch during the month of June 2011 is entered to win a real TIMEX brand watch exactly like the one sent as a semi-virtual gift. Once June is completed, a random drawings is held and a sender and a recipient of TIMEX brand watches receive free real watches identical to those sent or received. Such a contest increases the sales of semi-virtual gifts, and allows the sender and recipient to obtain real-world products in a V2R transformation.

Alternatively, any person sending a semi-virtual gift of any type is entered to win one or more real gifts that do not necessarily correspond to the same semi-virtual gift. For example, anyone sending a semi-virtual TIMEX brand watch during the month of June 2011 is entered to win a one hour spa treatment. Thus, every sender (alternatively or additionally every recipient) of a semi-virtual gift for the time period chosen is entered to win one of several real-world equivalents of semi-virtual gifts purchased that week, regardless of the semi-virtual gift sent or received by that person.

Another connection to the real world is when the system is connected to a dating site. If a man wishes to send a virtual gift to a woman on a web site, the man must purchase a gift from among the semi-virtual gifts. These can include a dozen roses, a bottle of wine, an expensive purse, a motorcycle and a PORSCHE brand automobile. The more expensive the real-world gift, the more expensive the semi-virtual gift. Thus, the $15,000 motorcycle might cost the man $150 to send to the woman. With this gift, the woman would receive real-world credit (V2R) in her account of $75 if she chooses to accept the gift. In one embodiment, the man who sends the gift includes a message with the gift, such as, “would you like to meet for coffee?” In order for the woman to be able to receive the real-world value of the gift, she must reply in substance to the man's message. For example, she could reply, “no, but thank you for the motorcycle.” Alternatively, she could reply, “yes, how is Saturday at 10 am?” In any case, in order for her to receive the real value (V2R) of the semi-virtual gift, she must respond to the man's communication.

The above example has significant value in the context of a dating web site, because it provides a way for a person to express his romantic interest in another person by sending a gift. Gifts commonly catch another person's attention, particularly if they show interest in the person, and convey the sender's degree of interest. If the sender is more willing to send an expensive gift, she is more interested in attracting the recipient's attention. And the more expensive the gift and real world value to the recipient, the more likely the recipient is to reply to the sender in a communication. In one embodiment, if there is no response after a predetermined period passes, the recipient loses his or her option of accepting, and the gift is returned to the sender. If the gift is returned to the sender, the sender may retain all of the real money spent on the gift, or only a portion.

Thus, it will become apparent that a person interested in someone on a dating site can send her a semi-virtual gift, for example a dozen roses. The recipient can accept, reject, return or re-gift the roses. If she accepts, the sender knows the recipient is interested. If she rejects, the sender knows the recipient is not interested. If she re-gifts or returns, the sender knows she might be interested and she appreciates the value of the gift. In any case, people on dating sites are aware of the value in attracting as many such semi-virtual gifts as possible, because those who attract many such gifts receive some real value in the gifts. It is contemplated that the person who accepts a gift also (or alternatively) receives virtual currency that is equal in value to the virtual gift's value. In the example above of the motorcycle, the recipient can receive $15,000 in semi-virtual dollars (or some other “currency”) and accumulate these to be (a) spent in the semi-virtual store on semi-virtual gifts, (b) to be spent in the semi-virtual store on real gifts; or (c) to be cashed out for some proportional amount of real currency.

In a contemplated example, a customer's account starts with four basic inventory categories: (1) semi-virtual money balance; (2) received gifts, (3) the customer's gift wish list, and (4) the customer's gifts created list. The account information interacts with a multitude of web sites, online games, social networks, and mobile phone applications so that the customer can populate her gift wish list.

Users can purchase and send semi-virtual gifts to other people by identifying the recipient in a variety of ways. First, users can select the recipient from a friend or contact list on a social network such as Facebook or any other source. Second, the user can send a gift to an email address that is already known or selected from a contact manager. Third, the user can send a gift to a unique online identification such as “single42” on a dating site. Fourth, the user can send a gift to a cell phone number. In all of these examples, the user identifies a unique identity that corresponds to a human being to whom the user sends a semi-virtual gift.

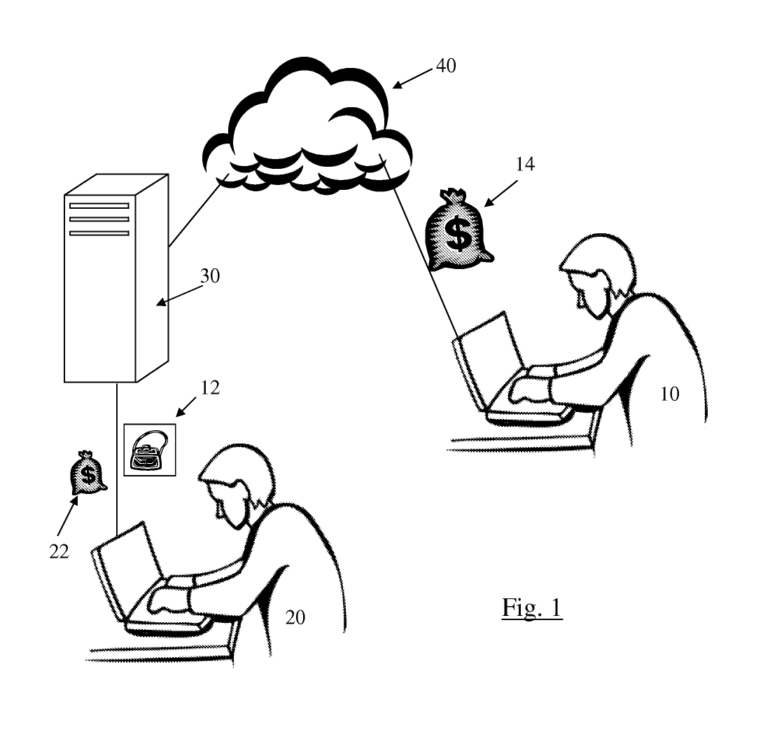

Referring to FIG. 1, once the recipient is identified, the customer 10 chooses a semi-virtual gift from a web site operated by a computer, such as the server 30. The customer sends money 14 to the server 30, such as across the internet 40, and the server sends an image 12 of the virtual gift to the recipient's 20 identified “mailbox”. Upon receipt, the recipient 20 can choose to keep the semi-virtual gift and all the virtual and real benefits that come with it, or the recipient can choose to ignore or refuse the gift. If the recipient chooses to accept the gift, and meets all the requirements of acceptance, then he or she can enjoy the virtual and real benefits thereof, and the real benefits can include a portion 22 of the money 14 spent by the customer. The next step the recipient takes may be to win a real-world equivalent of the semi-virtual gift in a sweepstakes. Alternatively, the recipient might use the real-world money to buy a physical product from the web site associated with the semi-virtual gift selling web site. If so, the physical product will be shipped or otherwise conveyed to the recipient of the semi-virtual gift, and the recipient can use the product. For example, if the product is a purse, the recipient can use the purse for its intended purpose. Likewise, if the product is a lamp, the recipient can use the lamp for its intended purpose.

Still further, the recipient might use the virtual value of the semi-virtual gift to purchase a semi-virtual gift for the sender or a third party. This can be by “returning” the semi-virtual gift, or it could involve taking the value accompanying the semi-virtual gift and applying it toward a different semi-virtual gift. Either of these would be accomplished in a manner similar to how the semi-virtual gift was first purchased by the sender. As another alternative, the recipient might re-gift the semi-virtual gift to a third party by a process similar to returning the gift—by simply designating a new, third party recipient.

Business to Business (B2B) gift-giving using semi-virtual gifts opens up an entirely new category of products and services that can be used for promotional purposes. A semi-virtual advertising premium can be sent to any valid email address or unique ID for a wide range of promotional purposes. This market is always looking for the “next big thing” and semi-virtual premiums could offer companies a way to provide branded giveaway merchandise (“swag”) with a much higher perceived value than a traditional item for the same amount of money. For example, a company can spend $1 to send a pen that has little value to the recipient or, for the same amount of money, they can send a semi-virtual coffee maker or other item with a “value” of $100. This makes the sender look more like it appreciates the recipient than an inexpensive pen, and gives the sender a “theme” in its gift. Furthermore, if the recipient wins the V2R contest, the recipient receives something worth $100.

Users can convert their semi-virtual dollars into real currency (such as U.S. dollars) to be sent via check, PayPal, loaded onto a prepaid debit card such as a VISA gift card, or sent in any other way currency is transferred. In addition, users may use their semi-virtual dollars to purchase goods or services online such as iTunes downloads or real-world, physical products from online retailers that are made available through a semi-virtual web page.

Users can also “create” their own semi-virtual gifts. For example, one could create a cute stuffed animal, fast car, tasty confection or other item that can be sold via a web site dedicated to the same. The more appealing the price and other features, the more likely senders will purchase and send the items as semi-virtual gifts. The user earns a flat rate or percentage of sales of the semi-virtual item as a royalty. Users thus have an incentive to spread the word so they can earn money, which increases sales of the created and other items.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of a sender sending a virtual gift and an associated real gift to a recipient, the method comprising:
(a) the sender conveying money to a web site and communicating to the web site the identification of the recipient;
(b) the web site conveying to the recipient the virtual gift;
(c) the web site conveying to the recipient the real gift related to the virtual gift; and
(d) the recipient using the real gift in a physical step.

2. The method in accordance with claim 1, wherein the step of the web site conveying the real gift further comprises the step of adding money to an account the recipient has with the web site.

3. The method in accordance with claim 2, wherein the step of using the real gift in a physical step includes spending the money added to the account.

4. The method in accordance with claim 1, wherein the step of the web site conveying the real gift further comprises the step of shipping a real world equivalent of the virtual gift to the recipient.

5. The method in accordance with claim 4, further comprising
(a) entering the recipient into a contest;
(b) randomly selecting a winner from a group including the recipient and other people to receive a physical item associated with the virtual gift; and then
(c) conveying that physical item to the winner.

6. The method in accordance with claim 4, further comprising
(a) entering the recipient and the sender into a contest;
(b) randomly selecting a winner from a group including the recipient, the sender and other people to receive a physical item associated with the virtual gift; and then
(c) conveying that physical item to the winner.

7. A method of a sender sending a virtual gift and an associated real gift to a recipient, the method comprising:
(a) the sender conveying money to a web site and communicating to the web site the identification of the recipient;
(b) the sender sending a communication to the recipient along with the virtual gift;
(c) presenting to the recipient a choice between sending a communication to the sender in order to receive the real gift and failing to send a communication to the sender in order to forfeit the real and virtual gifts;
(d) the recipient sending a communication to the sender;
(e) the web site conveying to the recipient the real gift related to the virtual gift; and
(f) the recipient using the real gift in a physical step.

8. The method in accordance with claim 7, wherein the step of the web site conveying the real gift further comprises the step of adding money to an account the recipient has with the web site.

9. The method in accordance with claim 7, wherein the step of the web site conveying the real gift further comprises the step of shipping a real world equivalent of the virtual gift to the recipient.

10. The method in accordance with claim 9, further comprising randomly selecting a winner from the recipient and the sender to receive a physical item associated with the virtual gift and conveying that physical item to the winner.

11. The method in accordance with claim 8, wherein the step of using the real gift in a physical step includes spending the money added to the account.
